(19) United States
(12) Patent Application Publication
(10) Pub. No.: US 2014/0254649 A1
(43) Pub. Date: Sep. 11, 2014

(54) RATE ADAPTATION ALGORITHM USING RAW BIT ERROR RATE

(71) Applicant: QUALCOMM INCORPORATED, San Diego, CA (US)

(72) Inventors: Hassan Afkhami, Ocala, FL (US); Purva R. Rajkotia, Orlando, FL (US); Manjunath Anandarama Krishnam, Gainesville, FL (US)

(73) Assignee: QUALCOMM INCORPORATED, San Diego, CA (US)

(21) Appl. No.: 13/788,811

(22) Filed: Mar. 7, 2013

(51) Int. Cl. H04L 1/00

(52) U.S. Cl. CPC H04L 1/0002
USPC 375/224

(57) ABSTRACT

Rate adaptation in network communications can be determined, at least in part, by bit error rates through network communication channels. Bit error rates can provide an indication of channel conditions and can guide selection of data rate settings by network devices. Relatively good channel conditions can support relatively higher data rates while communication channels with relatively more noise and/or interference can support relatively lower data rates. Transmitted data can be coded with Forward Error Correction codes that can allow determination of bit error rates resulting from transmission. In one embodiment, bit error rates can guide carrier selection when data is transmitted with groups of two or more carriers such as with orthogonal frequency division multiplexing modulation.

### BACKGROUND

Embodiments of the inventive subject matter generally relate to the field of communication systems and, more particularly, to rate adaptation for a communication system based, at least in part, on raw bit error rate.

In network communication systems, data can be transmitted from a first network device through a communication channel to a second network device. The data transmission rate can be selected in accordance with communication channel conditions. When the communication channel has improved channel conditions, then higher data rates reliably can be transmitted. However, when the communication channel has increased noise and/or interference, data more reliably can by decreasing data rates. Commonly, a signal-to-noise ratio (SNR) metric is used to determine conditions within the communication channel. SNR is oftentimes determined by transmitting and receiving known sequences which can reduce overall throughput since the known sequences typically do not carry data.

### SUMMARY

Disclosed are various embodiments of adapting a data transmission rate of a network device for use in a communication channel. In one embodiment, a target raw bit error rate for a first network device can be determined for transmitting data. The first network device can include a physical interface for communicating through the communication channel and a first physical interface setting can be selected for the physical interface. The first network device can transmit data to a second network device and the first network device can receive an actual raw bit error rate associated with the transmitted data. The physical interface setting can be modified in accordance with a determined difference between the target and the actual raw bit error rates.

### BRIEF DESCRIPTION OF THE DRAWINGS

The present embodiments may be better understood, and numerous objects, features, and advantages made apparent to those skilled in the art by referencing the accompanying drawings.

FIG. 1 is an exemplary system diagram illustrating a rate adaptation method in a communication network.

FIG. 2 is block diagram of one embodiment of a network device employing a rate adaptation mechanism.

FIG. 3 is a block diagram of another embodiment of a network device employing a rate adaptation mechanism.

FIG. 4 is a block diagram of yet another embodiment of a network device employing a rate adaptation mechanism.

FIG. 5 is a flow diagram illustrating example operations for adjusting a PHY data rate in accordance with a raw bit error rate.

FIG. 6 is a block diagram of an exemplary embodiment of an electronic device including a rate adaptive physical interface for network communications.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to wireless networks implementing IEEE 802.11n protocols, other wireless protocols can be used such as BLUETOOTH ®. Similarly, although orthogonal frequency division multiplexing (OFDM) modulation is specifically used in examples, other modulation schemes can be practiced. In other instances, well-known instruction instances, protocols, structures and techniques have not been shown in detail in order not to obfuscate the description.

In network communication systems, data can be transmitted from a first network device through a communication channel to a second network device. The data transmission rate can be selected in accordance with communication channel conditions. For example, higher data rates can be selected when relatively good (interference free, low noise) channel conditions with less noise are present. In contrast, lower data rates can be selected when channel conditions include relatively more noise and/or interference. Data rates are usually controlled by settings at a physical (PHY) interface at each network device. The PHY interface usually includes components related to the physical interface with the communication channel.

A signal-to-noise ratio (SNR) is a signaling metric that can be used to determine channel conditions within the communication channel. The SNR can describe the difference between a received signal and a perceived noise floor. In some communication systems, the SNR can be measured and a PHY data rate can be selected in accordance with the SNR. For example, relatively noisier communication channels (lower SNR) can use lower PHY data rates while communication channels with less noise (higher SNR) can use relatively higher PHY data rates. The SNR determination can depend on known training sequences being sent through the communication channel. Unfortunately, these known sequences can reduce the actual data throughput through the communication channel since the training sequences typically do not carry data.

Relatively noisy communication channels can cause errors to be received with the transmitted data. Forward error correction (FEC) coding can be used to enhance communication sent through noisy channels. FEC coding can add extra (redundant) data to the transmitted data. When the transmitted data is received, the FEC data can be used to detect and correct errors that may have been introduced into the data during transmission via the communication channel.

Oftentimes, transmitted data can be arranged into blocks. FEC coding can detect and correct small errors that can have been introduced when block data is transmitted through the communication channel. A block error rate can be defined by a ratio of blocks that could not be correctly received to a number of blocks that were received. Determining the block error rate can provide some feedback beyond SNR measurements to assist in selecting a PHY data rate. The block error rate can directly correspond to actual channel conditions. Unfortunately, a block error rate is a coarse metric in that blocks either succeed or fail. Moreover, many communication systems prefer to operate with a block error rate close to zero, therefore a measured block error rate of zero may not provide much information to help select a faster PHY data rate.

Similar to the block error rate is a packet error rate. FEC coding can detect and correct small errors that can have been introduced when packets of data are transmitted through the communication channel. A packet error rate can be defined as a ratio of packets that could not be correctly received to a number of packets that were received. The packet error rate may still be too coarse of a metric to help select PHY data rates in accordance with channel conditions.

One embodiment of a PHY rate adaptation method can use a determined raw bit error rate to guide selection of PHY data rates. The raw bit error rate (BER) can be defined as a ratio of corrected data bits to a total number of received data bits. The raw BER can provide an indicator of communication channel conditions without the need for training sequences which may improve the actual throughput through the communication channel.

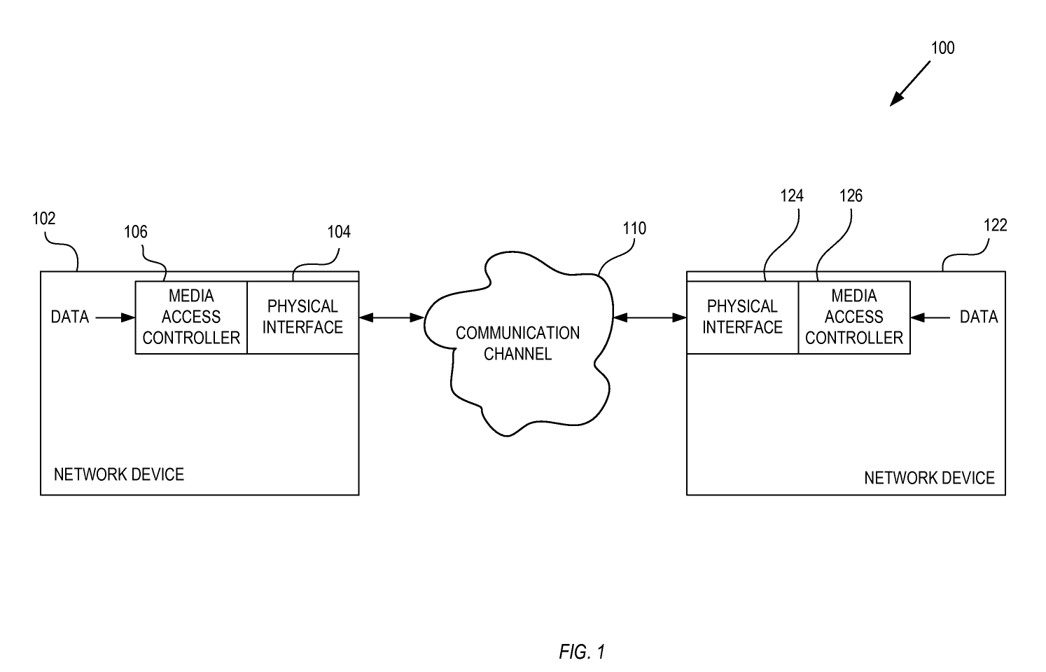

FIG. 1 is an exemplary system diagram 100 illustrating a rate adaptation method in a communication network. The system can include first network device 102 and second network device 122. Other systems can include more than two network devices. First network device 102 can include physical (PHY) interface 104 and media access controller 106. PHY interface 104 can provide a physical interface between the first network device 102 and communication channel 110. For example, if communication channel 110 is a wireless medium, then PHY interface 104 can include a wireless transmitter and receiver. If communication channel 110 is wired medium (copper wire, Ethernet over powerline, etc.), then PHY interface 104 can include signaling couplers to transmit and receive signals through the wired medium. Data to be transmitted from first network device 102 can be presented to media access controller (MAC) 106. MAC 106 can format data prior to passing data to the PHY interface 104. For example, MAC 106 can format data into data blocks before the PHY interface 104 transmits the data to the communication channel 110.

Second network device 122 can be similar to first network device 102, including PHY interface 124 and MAC 126, which in some embodiments function similarly to PHY interface 104 and MAC 106 respectively. For example, PHY interface 124 can receive data from communication channel 110 and process and pass the data to MAC 126. MAC 126 can then deliver the data for processing within second network device 122.

By way of example, and not limitation, a rate adaptation method can use an actual raw BER to determine, at least in part, PHY interface 104 settings related to PHY data rates for data transmissions from first network device 102 through communication channel 110 to second network device 122. In one embodiment, an actual raw BER can be compared to a target raw BER. The outcome of this comparison can be used to guide the selection of PHY data rates for PHY interface 104. Actual raw BERs can be determined at a receiving network device, such as second network device 122, particularly when transmitted data is FEC coded. That is, FEC coded data transmissions can be decoded and a number of incorrect bits (bits received in error) can be determined relative to a total number of bits received to determine the actual raw BER. The actual raw BER can be received by the first network device 102. In one embodiment, when the actual raw BER is greater than the target raw BER, then PHY interface 104 can receive settings for a lower data rate. Alternatively, when the actual raw BER is less than the target raw BER, then the PHY interface 104 can receive settings for a relatively higher data rate.

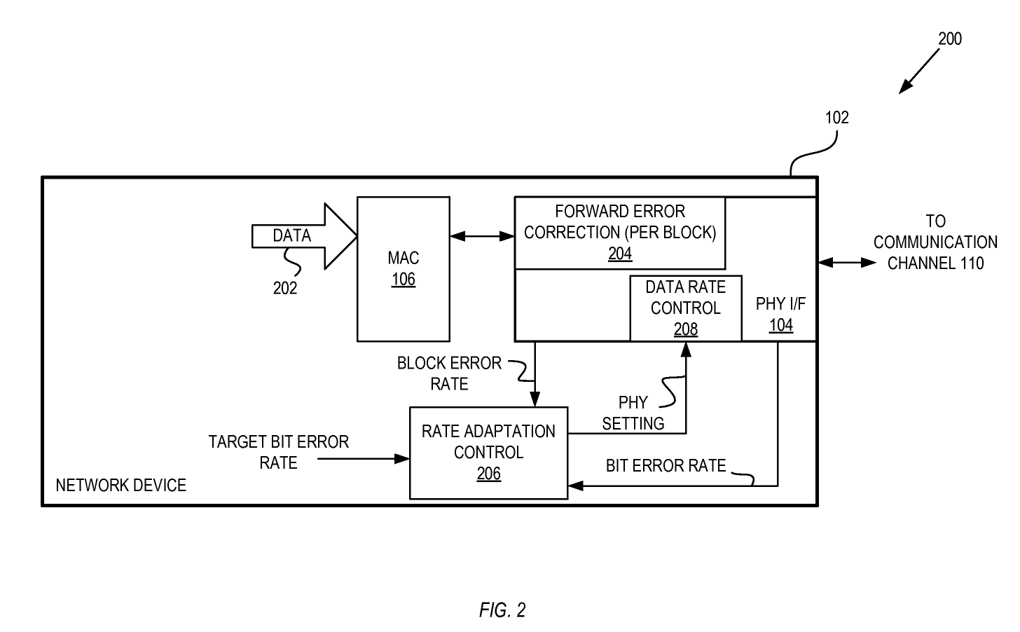

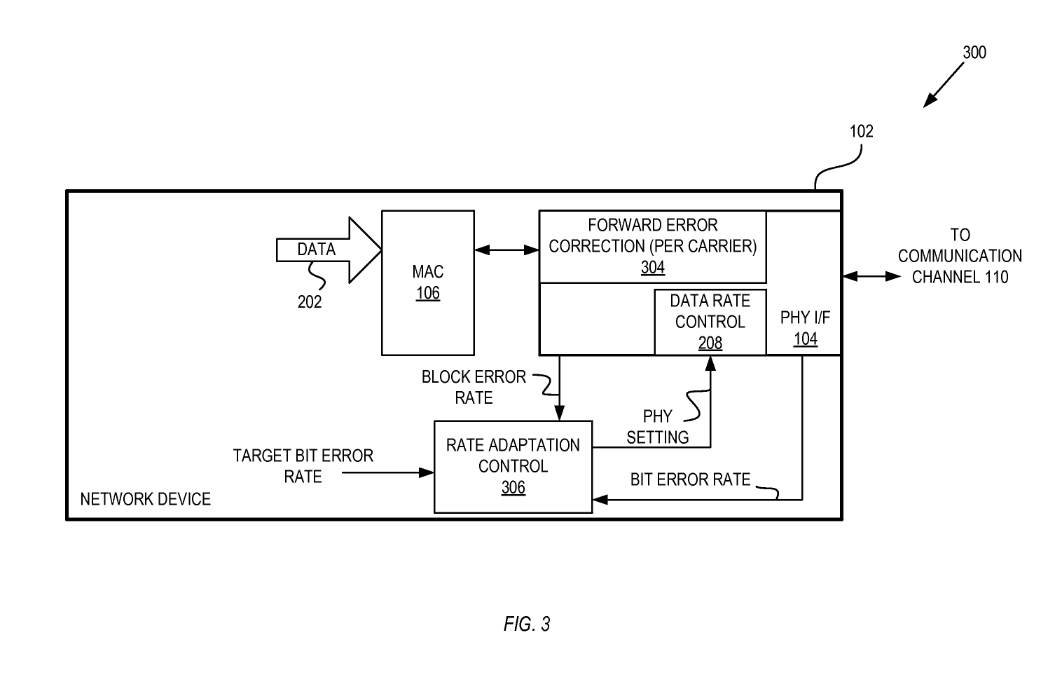

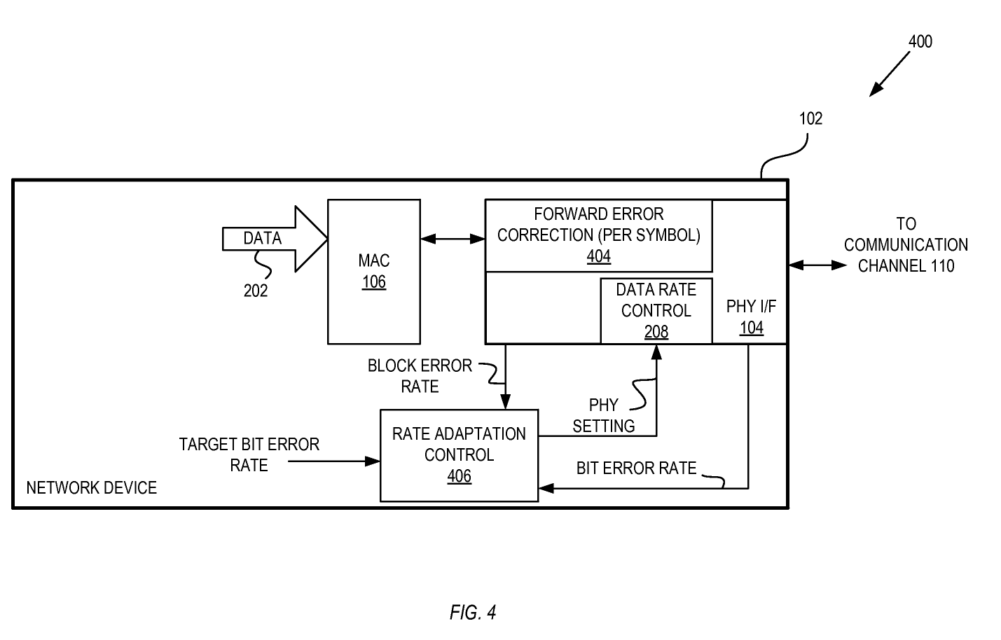

In one embodiment, before first network device 102 transmits data through the communication channel 110, a target raw BER can be determined. The target raw BER can be determined empirically or experimentally. In one embodiment, the target raw BER can be determined, at least in part, by a selected FEC coding scheme. More robust FEC coding schemes can be more tolerant of bit errors. For example, an FEC convolutional code with a code rate of 0.5 can be found to have a block error rate of 1 block in 100 when the raw BER is 2%. If that block error rate is acceptable, then the raw BER of 2% can be set as the target raw BER for network device 102. As will be further described below, the target raw BER can be used by first network device 102 to guide the selection of PHY data rates. A target raw BER related to block data transfer can be determined when data is arranged into blocks prior to transmission. A target raw BER related to block data transfer can be used to guide PHY data rate selection and will be described in conjunction with FIG. 2. A target raw BER can also be related to an individual carrier particularly when two or more carriers are used to transmit data through communication channel 110 such as when OFDM modulation is used to transmit data, which will be discussed in conjunction with FIG. 3. Additionally, a target raw BER can be related to individual time-domain symbols that can be used to transmit data through the communication channel, as will be discussed in conjunction with FIG. 4.

In some embodiments, when determining the target raw BER, configuration of related FEC encoders on the transmitter side and FEC decoders on the receiver side (in addition to the type of FEC code) can be taken into account. For example, relatively lower code rates can provide more parity bits available for correction. Thus, relatively lower code rates can increase the target raw BER. Also, block size can influence target raw BER. Increasing block sizes can provide more code gain and increase tolerated bit errors, and therefore, increase the target raw BER. Many FEC decoders can be iterative in nature. FEC performance can be determined, in part, by the number of iterations made in the decoder. While more iterations can increase the target raw BER, higher data rates can provide less time for iterations, thus reducing the target raw BER.

Initial PHY settings can be selected for use by network device 102. As described above, PHY settings can determine a data transmission rate. In one embodiment, PHY settings can be stored in PHY interface 104. In another embodiment, PHY settings can be stored in a register separate from PHY interface 104 and written or transferred to PHY interface 104 when network device 102 is in operation. In some embodiments, initial PHY settings can depend on a particular selected communication channel and/or any protocols used within the communication channel. For example, if communication channel 110 is a wireless channel and protocols defined by the IEEE 802.11n standard are followed, then initial PHY settings may be selected from one of the modulation and coding schemes (MCS) specified within the IEEE 802.11n standard. Alternatively, if communication channel 110 is a powerline channel and protocols defined by the IEEE 1901.2010 standard are followed, then initial PHY settings may be selected from one of the supported carrier modulation formats described within the IEEE 1901.2010 standard specification.

Data can be sent through communication channel 110 from first network device 102 to second network device 122. For example, data can be transmitted from PHY interface 104, through communication channel 110 to PHY interface 124. FEC coding data can be added to the transmitted data by PHY interface 104. In other embodiments, FEC coding data can be added to data by other blocks or modules (not shown) within first network device 102.

An actual raw BER can be determined at the second network device 122. As described above, the raw bit error rate (BER) can be defined to be a ratio of corrected data bits to a total number of received data bits. In one embodiment, the actual raw BER can be determined by PHY interface 124. In other embodiments, the raw BER can be determined by other blocks or modules (not shown) within second network device 122. Since FEC coded data includes both information and parity bits, second network device 122 can decode and correct the received data from the coded data. In some embodiments, data can be corrected with a FEC decoder (not shown). If the FEC decoder is able to decode the received data correctly, then the FEC decoder can estimate the number of bits that needed to be corrected and can determine the actual raw BER. The actual raw BER can be representative of conditions within communication channel 110. For example, relatively high raw BERs can indicate relatively noisy channel conditions while relatively low raw BERs can indicate a relatively more quite channel condition. Actual raw BERs can be determined, at least in part, by detecting and correcting errors indicated by the FEC coded data.

First network device 102 can receive the actual raw BER from the second network device 122. In one embodiment, the actual raw BER can be sent within a directed message from second network device 122 to first network device 102. In another embodiment, the actual raw BER can be sent from second network device 122 in response to a query from first network device 102. First network device 102 can adjust PHY settings in accordance with the actual raw BER and the target raw BER. For example, if the actual raw BER is greater than the target raw BER, then the PHY settings can be adjusted downward to allow for slower, more robust data transmission. On the other hand, if the actual raw BER is less than the target raw BER, then the PHY settings can be adjusted upward to allow for a faster data transmission. In one embodiment, the PHY settings can be adjusted such that the actual raw BER can be close to, but less than a rate that can cause more errors than can be corrected by second network device 122. In other words, the PHY settings can be used to manipulate the actual raw BER to increase data throughput while not exceeding an amount of errors that can be corrected by a FEC decoder.

FIG. 2 is block diagram 200 of one embodiment of a network device 102 employing a rate adaptation mechanism. Although FIG. 2 shows details of first network device 102, the details therein can apply to other network devices in system 100. In some implementations data 202 to be transmitted can be received by MAC 106. MAC 106 can provide a data interface between components and modules within network device 102 and the communication channel 110 through PHY interface 104. Data from MAC 106 can be received by FEC coder 204 in PHY interface 104. FEC coder 204 can apply FEC coding to data 202. In some implementations, FEC codes can be convolutional codes, turbo convolutional codes, Reed-Solomon codes, low density parity check codes or any other technically feasible codes. As described below, in other embodiments, FEC coded data can be used to detect and correct errors within data blocks.

Rate adaptation control module 206 can provide PHY settings to data rate controller 208 in PHY interface 104. The provided PHY settings can include an initial PHY data rate setting as described in stage B above. In one embodiment, data rate controller 208 can determine modulation characteristics for data to be transmitted into communication channel 110. PHY interface 104 can transmit data from MAC 106 at the data rate determined by data rate control module 208 to communication channel 110.

PHY interface 104 can receive a determined actual raw BER from a separate, network device that has received the data transmitted from the network device 102 (such as second network device 122 described above). In one embodiment, PHY interface 124 can provide the actual raw BER to rate adaptation control module 206. In other embodiments, the actual raw BER can be provided by other modules such as MAC 126. Rate adaptation control module 206 can compare the actual raw BER to the target raw BER. In one embodiment, the target raw BER can be determined by rate adaptation control module 206. In another embodiment, target raw BER can be received by and stored in rate adaptation control module 206. For example, software or firmware can determine and store the target raw BER in the rate adaptation control module 206. If the actual raw BER is greater than the target raw BER, then rate adaptation control module 206 can select a slower data rate PHY setting for data rate controller 208. Alternatively, if the actual raw BER is less than the target raw BER, then rate adaptation control module 206 can select a faster data rate PHY setting.

In one embodiment, the actual raw BER is to be greater than or less than the target raw BER by a predetermined amount (a tolerance range) before any changes are made to the PHY settings. In one embodiment, if the actual raw BER is greater than the upper limit of the tolerance range, then PHY settings selects a slower data rate PHY setting. Alternatively, if actual raw BER is less than the lower limit of the tolerance range, then rate adaptation control module 206 can select a faster data rate PHY setting for data rate control block 208. In some embodiments, the tolerance may be a predetermined buffer amount and, in some embodiments, can provide hysteresis to the PHY setting adjustments. In this manner, raw BER that is observed in communication channel 110 can be used by network device 102 to select PHY settings and affect data transmission speeds.

In one embodiment, PHY interface 104 can also receive block error rates as observed by a receiving network device (e.g., network device 122 in FIG. 1). As described above, data can be arranged into data blocks prior to transmission into communication channel 110. FEC data can also be used to determine (i) if data blocks were received without error and (ii) a block error rate. For example, second network device 122 can receive block data and use FEC coded data to determine BER (e.g., a ratio of data blocks that could not be corrected to a number of data blocks that were received). Similar to adjusting PHY settings described above, in some embodiments, if observed block error rates appear relatively high (e.g., compared to a target block error rate), then, in one embodiment, the target raw BER can be reduced accordingly. Alternatively, if observed block error rates appear relatively low, then target raw BER can be increased accordingly. By changing the target raw BER, PHY interface 104 settings can be optimized to provide a data rate in accordance with channel conditions. In one embodiment, observed actual block error rates can be greater or smaller by a predetermined amount compared to a target block error rate (a tolerance range) before any changes are made to target raw BER.

For example, in one embodiment, if the actual raw block error rate is greater than the upper limit of the tolerance range, then the target raw BER is reduced. Alternatively, if actual raw block error rate is less than the lower limit of the tolerance range, then the target raw BER can be increased.

FEC code performance can depend, at least in part, on the type of noise present in communication channel 110. While many FEC codes can perform well in the presence of Gaussian noise, some FEC codes may not perform well in the presence of time-domain (short bursts of noise) or frequency domain (noise in a particular frequency such as radio transmissions) noise sources. In such instances allowing target raw BER to be flexible can offer some advantages. For example, a noise pattern (time-domain or frequency domain) can be identified and a pattern for the target raw BER to correct the noise can be calculated. In one embodiment, a range for the target raw BER can be determined (e.g., determining the range from the target raw BER pattern determined).

FIG. 3 is a block diagram 300 of another embodiment of a network device 102 employing a rate adaptation mechanism. In this embodiment, data can be transmitted though communication channel 100 using a group of individual carriers, where each carrier can have a modulation or coding scheme different from other individual carriers. For example, an OFDM modulation system can be selected for use in network device 102. Each carrier can be a frequency domain carrier used by PHY interface 104 and can be considered an individual channel. In some implementations, an observed raw bit error rate associated with each carrier can be used to determine PHY settings for that carrier.

As described above, data 202 can be received by MAC 106. MAC 106 can provide a data interface between components and modules within network device 102 and the communication channel 110 through the PHY interface 104. Data from MAC 106 can be received by FEC coder 304 in PHY interface 104. In one embodiment, FEC coder can 304 apply FEC coding to individual carriers.

Rate adaptation control module 306 can select initial PHY settings for PHY interface 104 through data rate controller 208. In one embodiment, PHY settings can be data rate settings for individual carriers used to transmit data by PHY interface 104. In one embodiment, the target raw BER for each carrier can be provided by or stored in rate adaptation control module 306. In another embodiment, target raw BER for each carrier can received by rate adaptation control module 306. In another embodiment, target raw BER for each carrier can be received by and stored in rate adaptation control module 306. For example, software or firmware can determine and store the target raw BER for each carrier in the rate adaptation control module 306. PHY interface 104 can transmit data from MAC 106 at the data rate determined by data rate controller 208 to communication channel 110.

PHY interface 104 can receive an actual raw BER for each carrier from a separate, network device that has received the data transmitted from the network device 102 (such as second network device 122). In other embodiments, the actual raw BER for each carrier can be provided by other modules such as MAC 126. In one embodiment, PHY interface 124 can provide the actual raw BER for each carrier to rate adaptation control module 306. Rate adaptation control module 306 can compare the actual raw BERs for each carrier to target raw BERs for each carrier. If actual raw BER for a carrier is greater than target raw BER for the same carrier, then rate adaptation control module 306 can adjust the PHY settings for that carrier to provide a slower data rate setting. On the other hand, if actual raw BER for a carrier is less than the target raw BER for the same carrier, then rate adaptation control module 306 can adjust the PHY settings for that carrier to provide a faster data rate setting for that carrier can be selected. In this manner, PHY settings for each carrier can be individually adjusted to accommodate noise characteristics of communication channel 110.

In one embodiment, the actual raw BER for a carrier is greater than or less than the target raw BER for the same carrier by a predetermined amount (a tolerance range) before any changes can be made to the PHY settings. In one embodiment, if the actual raw BER for a carrier is greater than the upper limit of the tolerance range, then PHY settings for that carrier are selected for a slower data rate PHY setting. Alternatively, if actual raw BER for a carrier is less than the lower limit of the tolerance range, then rate adaptation control module 306 selects a faster data rate PHY setting for data rate controller 208 for that carrier. In some embodiments, tolerance may be a predetermined buffer amount and, in some embodiments, can provide hysteresis to the PHY setting adjustments. In this manner, raw BER for a carrier that is observed in communication channel 110 can be used by network device 102 to select PHY settings and affect data transmission speeds.

FIG. 4 is a block diagram 400 of yet another embodiment of a network device 102 employing a rate adaptation mechanism. In this embodiment, data can be transmitted though communication channel 100 using distinct time-domain symbols. An observed per-symbol raw BER can be used to select PHY data rate.

As described above, data 202 to be transmitted can be received by MAC 106. Data from MAC 106 can be received by FEC coder 404 in PHY interface 104. In one embodiment, FEC coder 404 can apply FEC coding to individual time-domain symbols.

Rate adaptation control module 406 can select initial PHY settings for PHY interface 104 through data rate controller 208. In one embodiment, PHY settings can be data rate settings for individual time-domain symbols used to transmit data by PHY interface 104. In one embodiment, the target raw BER for each time-domain symbol can be determined by rate adaptation control module 406. In another embodiment, target raw BER for each time-domain symbol can be received by and stored in rate adaptation control module 406. For example, software or firmware can determine and store the target raw BER for each time-domain symbol in the rate adaptation control module 406. PHY interface 104 can transmit data from MAC 106 at the data rate determined by data rate control module 208 to communication channel 110.

PHY interface 104 can receive determined actual raw BER for each time-domain symbol from a separate, network device that received the data transmitted from the network device 102 (such as second network device 122). In one embodiment, PHY interface 124 can provide the actual raw BER for each time-domain symbol to rate adaptation control module 406. In other embodiments, the actual raw BER for each time-domain symbol can be provided by other modules such as MAC 126. Rate adaptation control module 406 can compare the actual raw BER for each time-domain symbol to target raw BER for each time-domain symbol. If the actual raw BER for a time-domain symbol is greater than the target raw BER for the same time-domain symbol, then rate adaptation control module 406 can adjust the PHY settings for that time-domain symbol to provide a slower data rate setting. On the other hand, if the actual raw BER for a time-domain symbol is less than the target raw BER, then rate adaptation control module 406 can adjust the PHY settings for a faster data transmission for that time-domain symbol. In this manner, PHY settings for each time-domain symbol can be individually adjusted to accommodate noise characteristics of communication channel 110.

In another embodiment, if particular time-domain symbols are determined to have a relatively higher actual raw BER, then those time-domain symbols can be excluded from use. Some time-domain symbols can have a relatively higher BER because of particular characteristics (noise and/or interference) in communication channel 110. Data throughput through communication channel 110 can be improved by excluding those time-domain symbols with relatively higher BER. In other words, when transmitting data, time-domain symbols with an actual raw BER greater than a high error threshold can be excluded from use in data transmissions. In one embodiment, the high error threshold can be determined by rate adaptation control module 406. In other embodiments, the high error threshold can be determined by other modules in network device 102 (not shown).

In one embodiment, the actual raw BER is to be greater than or less than the target raw BER by a predetermined amount (a tolerance range) before any changes can be made to the PHY settings. In one embodiment, if the actual raw BER is greater than the upper limit of the tolerance range, then PHY settings selects a slower data rate PHY setting. Alternatively, if actual raw BER is less than the lower limit of the tolerance range, then rate adaptation control module 406 can select a faster data rate PHY setting for data rate controller 408. In some embodiments, the tolerance range may be a predetermined buffer amount and, in some embodiments, can provide hysteresis to the PHY setting adjustments. In this manner, raw BER that is observed in communication channel 110 can be used by network device 102 to select PHY settings and affect data transmission speeds.

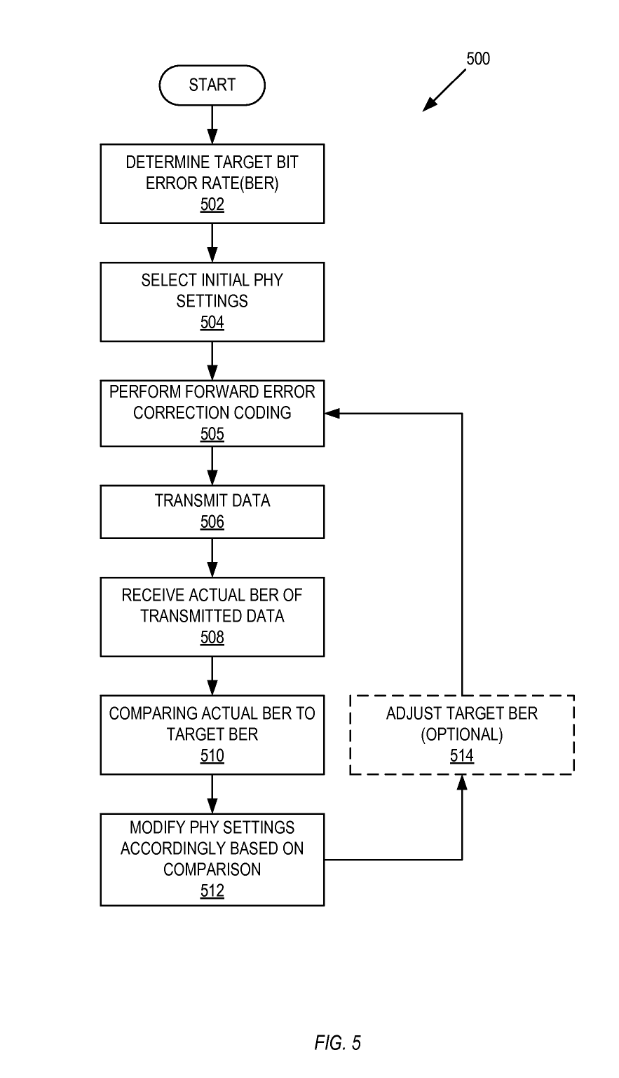

FIG. 5 is a flow diagram 500 illustrating an embodiment of example operations for a network device to adjust a PHY data rate in accordance with a raw bit error rate. The method of FIG. 5 is described with reference to the network devices 102 of FIGS. 1-4 (for illustration purposes and not as a limitation of the invention). The example operations can be carried out by one or more components of the network device 102, such as a processor within the network device or other modules within the network device such as a rate adaptation control module (e.g., 206, 306 or 406 described above). Beginning with 502, the network device 102 determines a target raw BER. The target raw BER can be determined in accordance with a selected FEC coding scheme to be used when transmitting data. As described above, different FEC codes can be more or less tolerant of bit errors introduced into data when transmitted through communication channel 110. For example, when an FEC code can tolerate a relatively greater amount of bit errors, then a relatively higher target raw BER can be determined. Proceeding to 504, the network device 102 selects initial PHY settings. The initial PHY settings determine initial data transfer rates for the PHY interface 104. In some embodiments, initial PHY settings can be based, at least in part, on SNR measurements. In other embodiments, initial PHY settings can be provided by a rate adaptation control module.

Proceeding to 505, the network device 102 applies the selected FEC coding to the data to be transmitted. FEC codes can enable bit error detection and correction. In some embodiments, FEC coded data can enable the detection and correction of transmitted data blocks. In some other embodiments, FEC coded data can also enable detection and correction of erroneous carriers. For example, when an OFDM modulation is used to transmit data, FEC coded data can be used to detect when one or more carriers used within the OFDM modulation are received in error. In still other embodiments, FEC coded data can enable detection and correction of erroneous time-domain symbols. For example, when FEC coded data is transmitted through distinct time-domain symbols, FEC coded data can be used to detect when one or more time-domain symbols have been received in error.

Proceeding to 506, the network device 102 transmits the data through the communication channel 110 to second network device 122 (FIG. 1). For example, if communication channel 110 is a wireless medium, then first network device 102 transmits data wirelessly in accordance with one or more wireless protocols such as IEEE 802.11 or Bluetooth. In another example, if communication channel 110 is a powerline medium, then first network device 104 can transmit data in accordance with a powerline protocol described by IEEE 1901.2010 or a protocol described by the Homeplug® Alliance.

Proceeding to 508, the actual raw BER of the transmitted data is received. In one embodiment, network device 122 can determine and send the actual raw BER to network device 102. In other embodiments, network device 102 may be able to determine the actual raw BER, for example, through receiving tangential information from the network device 122 or other information from the communication medium 110.

Proceeding to 510, the network device 122 compares the actual raw BER to the target raw BER. Proceeding to 512, the network device 102 may adjust the PHY settings as described above in accordance with the comparison of the actual raw BER and the target raw BER. Proceeding to 514, network device 102 can adjust the target raw BER. This step can be optional as shown by the dashed lines in FIG. 5. The target raw BER can be adjusted upward or downward as conditions merit. For example, if actual raw BERs are determined to be relatively high, then data transmitted by network device 102 can include relatively large amounts of errors. Lowering the target raw BER can enable PHY settings to be adjusted downward to reduce data transmission rates that can reduce the actual raw BER. Alternatively, if the actual raw BER is determined to be relatively low, then increased data transmission rates can be supported by. Increasing the target raw BER can enable PHY settings to be adjusted upward to increase data transmission rates to increase data bandwidth through communication channel 110. Next, the method can return to step 505. In this way, the method can repeatedly evaluate the current performance of network device 102 and make adjustments to PHY settings responsive to changing communication channel 110 conditions.

Flow diagram 500 can apply to the rate adaptation described in FIGS. 2, 3 and 4. For example, target raw BER (step 502) and actual raw BER (step 508) can be raw BERs for each carrier when applied to FIG. 3. Also, target raw BER and actual raw BER can be raw BERs for individual time-domain symbols as described in FIG. 4.

It should be understood that FIGS. 1-5 and the operations described herein are examples meant to aid in understanding embodiments and should not be used to limit embodiments or limit scope of the claims. Embodiments may perform additional operations, fewer operations, operations in a different order, operations in parallel, and some operations differently. For example, initial PHY settings in step 504 can be determined before determining a target raw BER in step 502.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

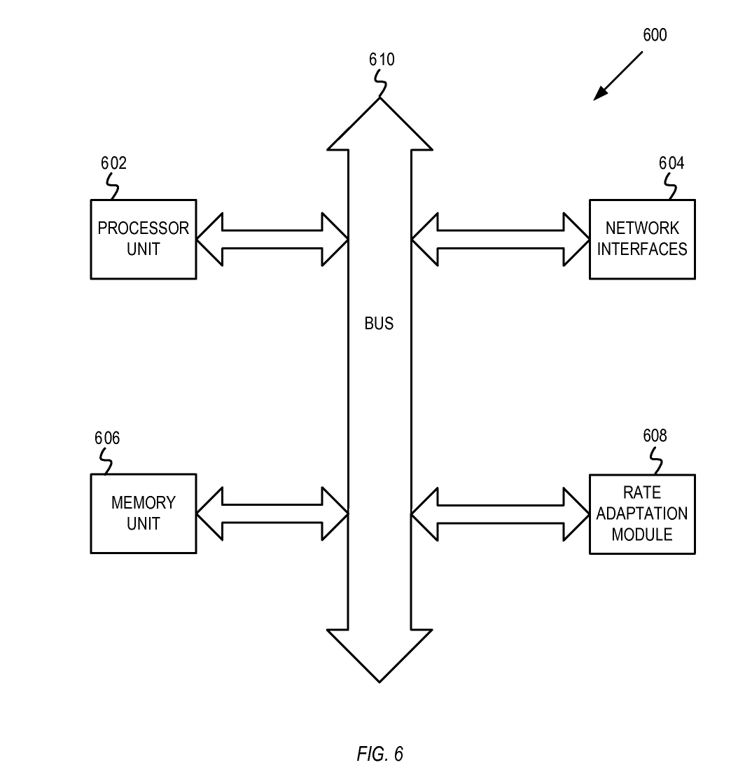

FIG. 6 is a block diagram of an exemplary embodiment of an electronic device 600 including a rate adaptive physical interface for network. In some implementations, the electronic device 600 may be one of a laptop computer, a tablet computer, a mobile phone, a powerline communication device, a smart appliance (PDA), or other electronic systems. The electronic device 600 can include processor unit 602 (possibly including multiple processors, multiple cores, multiple nodes, and/or implementing multi-threading, etc.). The electronic device 600 can also include memory unit 606. Memory unit 606 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. Electronic device 600 can also include bus 610 (e.g., PCI, ISA, PCI-Express, HyperTransport®, InfiniBand®, NuBus, AHB, AXI, etc.), and network interfaces 604 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, electronic device 600 may support multiple network interfaces—each of which is configured to couple the electronic device 600 to a different communication network.

Network interfaces 604 can include PHY interfaces 104, 124 as described in FIGS. 1-5 above. Other portions of network device 102 can be distributed within processor unit 602, memory unit 606 and bus unit 610.

Rate adaptation module 608 can include elements and modules described in conjunction with rate adaptation control modules 206, 306 and/or 406. In one embodiment, rate adaptation module 608 can include functionality to receive and compare actual and target raw BERs as well as adjust PHY settings within network interfaces 604.

The memory unit 606 can embody functionality to implement embodiments described in FIGS. 1-5 above. In one embodiment, memory unit 606 can include one or more functionalities that facilitate adjusting PHY settings in accordance with actual raw BER, more particularly to a difference between actual raw data rate and a target raw BER. In some embodiments, the difference between an actual raw BER and a target raw BER can be greater than or less than a predetermined amount before adjusting PHY settings. Any one of these functionalities may be partially (or entirely) implemented in hardware and/or on the processing unit 602. For example, the functionality may be implemented with an application specific integrated circuit, in logic implemented in the processing unit 602, in a co-processor on a peripheral device or card, etc. Further, realizations may include fewer or additional components not illustrated in FIG. 6 (e.g., video cards, audio cards, additional network interfaces, peripheral devices, etc.). Processor unit 602, memory unit 606, network interface 604 and rate adaptation module 608 are coupled to bus 610. Although illustrated as being coupled to the bus 610, memory unit 606 may be coupled to processor unit 602.

While the embodiments are described with reference to various implementations and exploitations, it will be understood that these embodiments are illustrative and that the scope of the inventive subject matter is not limited to them. In general, techniques for rate adaptation using raw BER as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
transmitting data from a first network device to a second network device, wherein the first network device uses a first physical interface setting for transmitting the data;
receiving, at the first network device, information related to an actual error rate associated with the transmitted data;
determining, from the received information, an actual error rate associated with the transmitted data;
comparing the actual error rate to a target error rate; and
selecting a second physical interface setting for transmitting data when the actual error rate differs from the target error rate by more than a predetermined threshold.

2. The method of claim 1, wherein the target error rate and the actual error rate are bit error rates.

3. The method of claim 1, wherein the first physical interface setting affects, at least in part, a data transmission rate of data through the communication channel.

4. The method of claim 3, wherein the second physical interface setting decreases the data transmission rate when the actual error rate is greater than the target error rate by more than the predetermined threshold.

5. The method of claim 3, wherein the second physical interface setting increases the data transmission rate when the actual error rate is less than the target error rate by more than the predetermined threshold.

6. The method of claim 1, wherein the target error rate and the actual error rate are associated with at least one carrier in an orthogonal frequency division multiplexing (OFDM) modulation system used to transmit data from the first network device.

7. The method of claim 6, wherein receiving information related to the actual error rate further comprises receiving information related to an actual error rate for the at least one carrier.

8. The method of claim 6, wherein the selecting the second physical interface setting further comprises selecting a physical interface setting for a slower data rate for the at least one carrier when the actual error rate for the at least one carrier is greater by more than the predetermined threshold than the target error rate for the same carrier.

9. The method of claim 6, wherein the selecting the second physical interface setting further comprises selecting a physical interface setting for a faster data rate for the at least one carrier when the actual error rate for the at least one carrier is less by more than the predetermined threshold than the target error rate for the same carrier.

10. The method of claim 1, wherein the data is arranged in blocks and the target error rate and the actual error rate are block error rates.

11. The method of claim 1, wherein the target error rate and the actual error rate are associated with at least one time-domain symbol used to transmit data from the first network device.

12. The method of claim 11, wherein the second physical interface setting reduces the usage of the at least one time-domain symbol when the actual error rate is greater by more than the predetermined threshold than the target error rate.

13. A network device comprising:
a physical interface configured to receive forward error correction (FEC) coded data and transmit the FEC coded data through a communication channel at a data transmission rate determined by a physical interface transmission setting; and
a rate adaptation control module configured to receive a target error rate and an actual error rate and adjust the physical interface transmission setting provided to the physical interface in accordance with differences between the target error rate and the actual error rate.

14. The network device of claim 13, wherein the target error rate and the actual error rate are bit error rates.

15. The network device of claim 13, wherein the physical interface further comprises a data rate control module configured to receive the physical interface transmission setting and select a data modulation for the physical interface in accordance with the physical interface transmission setting.

16. The network device of claim 15, wherein the data modulation determines, at least in part, a data transmission rate of the data transmitted from the physical interface.

17. The network device of claim 13, wherein the actual error rate is received from a second network device by the physical interface.

18. The network device of claim 13, wherein the target error rate and the actual error rate are associated with at least one time-domain symbol symbol used to transmit data from the network device.

19. The network device of claim 18, wherein the rate adaptation control module is further configured to reduce the usage of the at least one time-domain symbol when the actual error rate is greater than the target error rate.

20. The network device of claim 13, wherein the physical interface is further configured to format FEC coded data into blocks.

21. The network device of claim 20, wherein the physical interface is further configured to receive a block error rate and the rate adaptation control module is further configured to adjust the target error rate in accordance with the received block error rate.

22. The network device of claim 13, wherein the target error rate and the actual error rate are associated with at least one carrier of an OFDM modulation system used to transmit data from the network device.

23. The network device of claim 22, wherein the rate adaptation control module is further configured to configure the physical interface to reduce the usage of the at least one carrier when the actual error rate is greater than the target error rate.

24. A non-transitory machine-readable storage media having instructions stored therein, which when executed by one or more processors causes the one or more processors to perform operations that comprise:
determining a target error rate for transmitting data from a first network device to a second network device through a communication channel;
selecting a first physical interface setting for transmitting the data from the first network device;
transmitting data from the first network device to the second network device;
receiving, at the first network device, an actual error rate associated with the transmitted data; and
selecting a second physical interface setting for transmitting data when the actual error rate differs from the target error rate by more than a predetermined threshold.

25. The non-transitory computer readable storage media of claim 24, wherein the target error rate and the actual error rate are bit error rates.

26. The non-transitory computer readable storage media of claim 24, wherein the first physical interface setting affects, at least in part, a data transmission rate of data through the communication channel.

27. The non-transitory computer readable storage media of claim 26, wherein the second physical interface setting decreases the data transmission rate when the actual error rate is greater than the target raw bit error rate by more than the predetermined threshold.

28. The non-transitory computer readable storage media of claim 26, wherein the second physical interface setting increases the data transmission rate when the actual error rate is less than the target raw bit error rate by more than the predetermined threshold.

29. The non-transitory computer readable storage media of claim 24, wherein the target error rate and the actual error rate are associated with at least one carrier in an orthogonal frequency division multiplexing (OFDM) modulation system used to transmit data from the first network device.

30. The non-transitory computer readable storage media of claim 29, wherein the receiving the actual error rate further comprises receiving an actual error rate for the at least one carrier.

31. The non-transitory computer readable storage media of claim 29, wherein the the selecting the second physical interface setting further comprises selecting a physical interface setting for a slower data rate for the at least one carrier when the actual error rate for the at least one carrier is greater than the target error rate for the same carrier by more than the predetermined threshold.

32. The non-transitory computer readable storage media of claim 29, wherein the selecting the second physical interface setting further comprises selecting a physical interface setting for a faster data rate for the at least one carrier when the actual error rate for the at least one carrier is less than the target error rate for the same carrier by more than the predetermined threshold.

33. The non-transitory computer readable storage media of claim 24, wherein the target error rate and the actual error rate are associated with at least one time-domain symbol used to transmit data from the first network device.

34. An apparatus comprising:
means for transmitting data from a first network device to a second network device, wherein the first network device uses a first physical interface setting for transmitting the data;
means for receiving, at the first network device, information related to an actual error rate associated with the transmitted data;
means for determining from the received information an actual error rate associated with the transmitted data;
means for comparing the actual raw error rate to a target error rate; and
means for selecting a second physical interface setting for transmitting data when the actual error rate differs from the target error rate by more than a predetermined threshold.

35. The apparatus of claim 34, wherein the target error rate and the actual error rate are bit error rates.

36. The apparatus of claim 34, wherein the first physical interface setting affects, at least in part, a data transmission rate of data through the communication channel.

37. The apparatus of claim 36, wherein the second physical interface setting decreases the data transmission rate when the actual error rate is greater than the target error rate by more than the predetermined threshold.

38. The apparatus of claim 36, wherein the second physical interface setting increases the data transmission rate when the actual error rate is less than the target error rate by more than the predetermined threshold.

39. The apparatus of claim 34, wherein the target error rate and the actual error rate is associated with at least one carrier in an orthogonal frequency division multiplexing (OFDM) modulation system used to transmit data from the first network device.

40. The apparatus of claim 39, wherein receiving information related to the actual error rate further comprises receiving information related to an actual error rate for the at least one carrier.

41. The apparatus of claim 39, wherein the selecting the second physical interface setting further comprises selecting a physical interface setting for a slower data rate for the at least one carrier when the actual error rate for the at least one carrier is greater by more than the predetermined threshold than the target error rate for the same carrier.

42. The apparatus of claim 39, wherein the selecting the second physical interface setting further comprises selecting a physical interface setting for a faster data rate for the at least one carrier when the actual error rate for the at least one carrier is less by more than the predetermined threshold than the target error rate for the same carrier.

43. The apparatus of claim 34, wherein the data is in blocks and the target error rate and the actual error rate are block error rates.

44. The method of claim 34, wherein the target error rate and the actual error rate are associated with at least one time-domain symbol used to transmit data from the first network device.

45. The method of claim 34, wherein the second physical interface setting reduces the usage of the at least one time-domain symbol when the actual error rate is greater than the target error rate.

46. A system comprising:
a first network device comprising a first physical interface configured to transmit and receive data through a communication channel and a rate adaptation controller configured to adjust a data transmission rate of the first physical interface in accordance with an actual error rate associated with a data stream transmitted by the first network device, and
a second network device, communicatively coupled to the first network device through the communication channel, the second network device comprising a second physical interface configured to transmit and receive data through the communication channel, wherein the second network device is configured to receive the data stream transmitted by the first network device, determine the actual error rate associated with the received data stream and provide the actual error rate to the first network device.

47. The system of claim 46, wherein the data transmissions from the first network device are arranged into blocks and the actual error rate is a block error rate expressing a ratio of a number of blocks incorrectly received to a number of blocks received.

48. The system of claim 46, wherein the data transmissions from the first network device are arranged into carriers used in an orthogonal frequency division multiplexing (OFDM) modulation system and the actual error rate is a carrier error rate associated with at least one carrier expressing a ratio of a number of carriers incorrectly received to a number of carriers received for the at least one carrier.

49. The system of claim 48, wherein the rate adaptation controller is further configured to compare the actual error rate with a target error rate and adjust the data transmission rate for a slower data rate when the actual carrier error rate for at least one carrier is greater than by more than a predetermined threshold than the target error rate for the same carrier.

50. The system of claim 48, wherein the rate adaptation controller is further configured to compare the actual error rate with a target error rate and adjust the data transmission rate for a faster data rate when the actual carrier error rate for at least one carrier is less than by more than a predetermined threshold than the target error rate for the same carrier.

51. The system of claim 46, wherein the data transmissions from the first network device are arranged into bits and the actual error rate is a bit error rate expressing a ratio of number of bits incorrectly received to a number of bits received.
